(19) United States
(12) Patent Application Publication
(10) Pub. No.: US 2026/0260924 A1
(43) Pub. Date: Sep. 3, 2026

(54) SYSTEM FOR PRESSING AND CHARGING/DISCHARGING BATTERY CELL

(71) Applicant: LG ENERGY SOLUTION, LTD., Seoul (KR)

(72) Inventor: Sukhyun HONG, Daejeon (KR)

(21) Appl. No.: 18/995,799

(22) PCT Filed: Sep. 6, 2023
(86) PCT No.: PCT/KR2023/013345

§ 371 Date: Jan. 16, 2025

(30) Foreign Application Priority Data
Sep. 8, 2022 (KR) 10-2022-0113937

(51) Int. Cl. H01M 10/04; H01M 10/46; H02J 7/70

(52) U.S. Cl. CPC H01M 10/0481; H01M 10/46; H02J 7/70

(57) ABSTRACT

The present disclosure relates to a system for pressurizing and charging/discharging battery cells, including an inner frame into which battery cells are loaded, a plate for pressurizing the battery cell, a pressurizing block movable on the plate in the direction in which the plate extends, gripping the battery cell, and an outer frame disposed outside the inner frame and having an inner tab electrically connected with the pressurizing block by wiring.

### CROSS-REFERENCE TO RELATED APPLICATIONS

The present application is a National Phase entry pursuant to 35 U.S.C. § 371 of International Application No. PCT/KR2023/013345, filed on Sep. 6, 2023, and claims the benefit of and priority to Korean Patent Application No. 10-2022-0113937, filed Sep. 8, 2022, the entire contents of each of which are incorporated herein by reference for all purposes as if fully set forth herein.

### TECHNICAL FIELD

The present disclosure relates to a battery cell pressurization and charging/discharging system, and more particularly, to a battery cell pressurization and charging/discharging system in which a battery cell can be pressurized and charged/discharged without changing its inner frame, even if the size of the battery cell is changed.

### BACKGROUND

In recent years, as energy prices have risen due to the depletion of fossil fuels and environmental pollution has increased, there has been a growing need for environmentally friendly alternative energy sources. As a result, various power generation technologies such as nuclear, wind, tidal, and solar are being researched, and there is a growing interest in power storage to use the energy generated more efficiently.

In particular, the demand for batteries as an energy source is increasing rapidly as technology development and demand for medium and large-scale applications such as electric vehicles and energy storage systems (ESS) increases, and research is being conducted on batteries that can meet various needs.

For example, in terms of battery shape, there is a high demand for prismatic batteries and pouch batteries that are relatively thin, and in terms of materials, there is a high demand for lithium secondary batteries such as lithium-ion batteries, lithium-ion polymer batteries, and lithium all-solid-state batteries, which have advantages such as high energy density, discharge voltage, and output stability.

Such a secondary battery has an electrode assembly comprising an anode, a cathode, a separator disposed therebetween, and an electrolyte embedded inside a battery case, with anode and cathode tabs welded to two electrode tabs and sealed to be exposed to the outside of the battery case. These electrode tabs are electrically connected to an external device by contact therewith, and the battery can supply power to or receive power from the external device through the electrode tabs.

In one aspect, the secondary battery may be fabricated by accommodating the electrode assembly into the battery case and injecting electrolyte, followed by an activation step to activate the battery. The activation step may comprise framing the secondary battery in a charge and discharge device and then charging/discharging the secondary battery under pressure to the conditions required for activation.

If the size of the electrode assembly changes, the frame must be reused to fit the new size. As a result, the time and cost of fabricating the secondary battery is wasted. Therefore, research is being conducted to solve these problems.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

According to certain embodiments, it is an object of the present disclosure to provide a battery cell pressurization and charging/discharging system in which pressurization and charging/discharging can be performed using the same frame even when the size of the electrode assembly changes.

Furthermore, according to certain embodiments, it is an object of the present disclosure to provide a battery cell pressurization and charging/discharging system that allows for the use of a battery cell for capacity testing, rather than the use of a battery cell dedicated to charging/discharging. According to certain embodiments, to accomplish the aforementioned objectives of the present disclosure, a battery cell pressurization and charge/discharge system according to one embodiment of the present disclosure includes: an inner frame into which a battery cell is loaded; a plate for pressurizing the battery cell; a pressurizing block movable on the plate in a direction in which the plate extends, and gripping the battery cell; and an outer frame disposed outside the inner frame, and having an inner tab electrically connected with the pressurizing block by wiring.

In one embodiment, the pressurizing block may comprise a circuit board disposed in a portion in contact with the battery cell.

In one embodiment, the system may further comprise a load cell disposed within the inner frame and capable of measuring a pressure exerted on the battery cell.

In one embodiment, the system may further comprise a pressurizing shaft for pressurizing the plate, wherein the pressurizing shaft pressurizes the plate by rotation.

In one embodiment, the rotation may be a screw rotation.

In one embodiment, the pressurizing block may grip a tab of the battery cell.

In one embodiment, the battery cell may be a bilateral tabbed battery cell with tabs provided at both ends.

In one embodiment, the battery cell may be a unidirectionally tabbed battery cell having a tab provided at one end only.

In one embodiment, two or more pressurizing blocks may be disposed on the one plate.

In one embodiment, the system may further comprise: a transfer device to transfer the outer frame; and a charging/discharging device into which the transferred outer frame is placed, wherein the charging/discharging device has an outer tab electrically connected with the inner tab, and wherein a current applied by the charging device is transferred to the battery cell via the outer tab, the inner tab, and the pressurizing block.

In one embodiment, the outer tab may be a tab gripper that grips and electrically connects the inner tab.

In one embodiment, the inner tab and the pressurizing block maybe connected together by wiring that is in a form of a spring.

According to certain aspects of the present disclosure, a battery cell pressurization and charging/discharging system can pressurize battery cells of various sizes without changing the inner frame, by having pressurizing blocks movable on the plate gripping the tabs of the battery cells, regardless of the size of the battery cells.

Wiring disposed in the form of a spring may be elongated. Accordingly, in certain embodiments, the inner tabs may be connected to the pressurizing blocks by wiring that stretches in length while remaining fixed in position within the inner frame. If the pressurizing block is moved, according to certain embodiments, the position of the inner tabs may not change, and instead it is only the length of the wiring that may increase or decrease. The outer tab may be fixedly disposed in a position corresponding to the inner tabs within the outer frame.

Thus, according to certain embodiments, the battery cell pressurization and charging/discharging system can use same inner frame, outer frame, and charging/discharging device regardless of the size of the battery cells. Accordingly, the battery cell pressurization and charging/discharging system can save time and money compared to conventional pressurization and charging/discharging systems that require replacing the frame whenever the size of the battery cell changes.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a block diagram schematically illustrating a battery cell pressurization and charging/discharging system according to one embodiment of the present disclosure.

FIG. 2 is a drawing illustrating one embodiment of a pressurizing tray depicted in of FIG. 1.

FIG. 3 is a drawing of an one embodiment of a pressurized state of battery cell placed inside the pressurizing tray depicted in of FIG. 1.

FIGS. 4a to 4c are drawings illustrating one embodiment of a pressurizing block included in the pressurizing tray depicted of FIG. 1.

FIG. 5 is a drawing illustrating a cell battery pressurization and charging/discharging system according to one embodiment of the present disclosure.

FIG. 6 is a drawing illustrating a pressurizing tray according to one embodiment of the present disclosure.

FIG. 7 is a drawing illustrating a pressurizing tray according to another embodiment of the present disclosure.

FIGS. 8a to 8c are drawings illustrating one embodiment of a pressurizing block included in the pressurizing tray of FIG. 7.

### DETAILED DESCRIPTION

Hereinafter, preferred embodiments of the present disclosure will be described in detail with reference to the accompanying drawings. It should be noted that the terms and words used in this specification and claims are not necessarily to be construed in their ordinary or dictionary sense, but rather according to the meaning and concepts consistent with the technical ideas disclosed herein, and based on the principle that the inventor may be their own lexicographer to properly define the terms used to describe their invention. Accordingly, it is to be understood that the embodiments described in the specification and the configurations illustrated in the drawings are only some of the most preferred embodiments of the present disclosure and are not exhaustive of the technical ideas of the present disclosure, and that there may be various equivalents and modifications that may replace them at the time of filing.

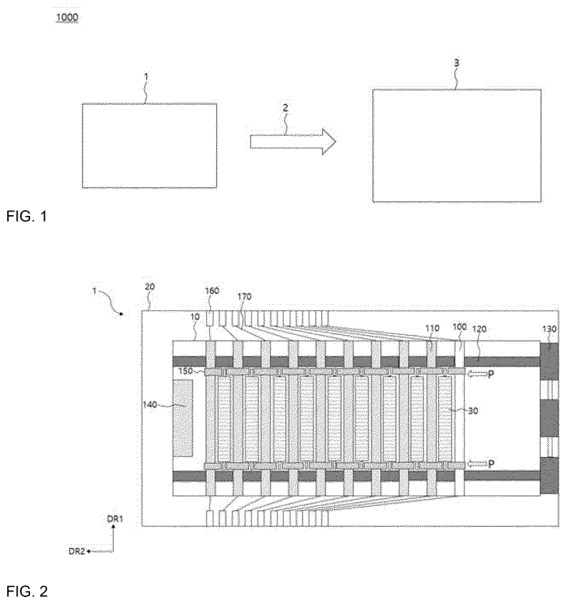

FIG. 1 is a block diagram schematically illustrating a battery cell pressurization and charging/discharging system according to one embodiment of the present disclosure.

Referring to FIG. 1, in one embodiment, a battery cell pressurization and charging/discharging system 1000 may include a pressurizing tray 1, a transfer device 2, and a charging/discharging device 3. The pressurizing tray 1 may pressurize battery cells. For this purpose, the pressurizing tray 1 may be loaded with the battery cells. The charging/discharging device 3 may charge and discharge the battery cells placed in the pressurizing tray 1. The process of charging/discharging the battery cells may be defined as an activation process that activates the battery cells. During the activation process, the battery cell may expand due to a change in the thickness of the electrode plate or gas generation. The battery cell pressurization and charging/discharging system 1000 allows the charging/discharging device 3 to charge the battery cell while the pressurizing tray 1 pressurizes the battery cell to prevent the battery cells from expanding.

The pressurizing tray 1 containing the battery cells may be transferred to the charging/discharging device 3 by the transfer device 2. The transfer device 2 can be used in various ways, as long as it is capable of transferring the pressurizing tray 1 to the charging/discharging device 3. The transfer device 2 may comprise a conveyor belt, a crane, or the like. As a crane, a stacker crane may be used. For example, in the pressurizing stage, the battery cells may be loaded into the pressurizing tray 1. The pressurizing tray 1 can be moved to the charging/discharging device 3 via a conveyor belt while pressurizing the loaded battery cells. A stacker crane may then load the pressurizing tray 1 into the charging/discharging device 3.

The pressurizing tray 1 may be introduced into the charging/discharging device 3 by the transfer device 2 in such a way that it is electrically connected to the charging/discharging device 3. The charging/discharging device 3 may apply a current to the pressurizing tray 1.

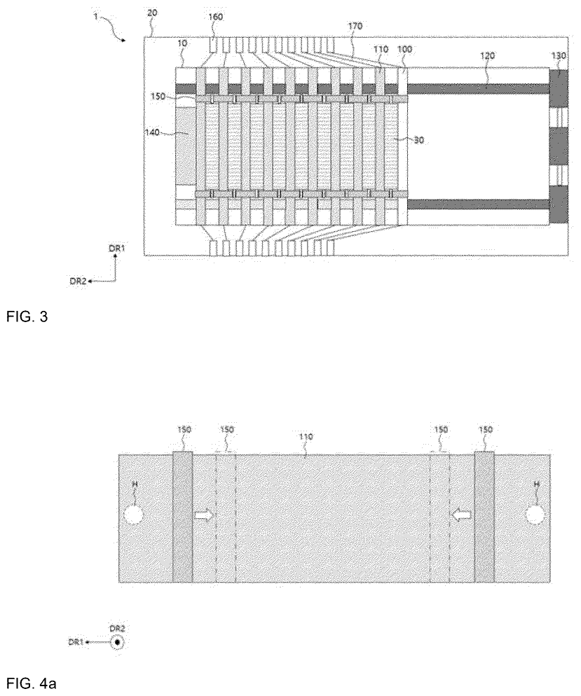

FIG. 2 is a drawing illustrating one embodiment of the pressurizing tray depicted in FIG. 1, and FIG. 3 is a drawing illustrating battery cells pressurized inside the pressurizing tray depicted in FIG. 1.

Referring to FIG. 2, according to certain embodiments, the pressurizing tray 1 may include an inner frame 10, an outer frame 20, battery cells 30, plates, pressurizing shafts 120, a pressurizing adjustment member 130, a load cell 140, pressurizing blocks 150, inner tabs 160, and wiring 170. The plates may include a main plate 100 and sub-plates 110.

According to certain embodiments, the inner frame 10 may provide a space in which the battery cells 30 are housed. The inner frame 10 may be made of rigid materials to accommodate and secure the battery cells 30. The inner frame 10 may be loaded with the battery cells 30. The battery cells 30 may be activated by pressurizing and charging/discharging the battery cells 30 after they are inserted into the inner frame 10. At least one battery cell 30 may be introduced into the inner frame 10.

According to certain embodiments, the main plate 100 and the sub-plates 110 may pressurize the battery cells 30. To this end, according to certain aspects, the main plate 100 may have a plate-like structure. The main plate 100 may extend in a first direction DR1. The main plate 100 may pressurize in a second direction DR2 that is perpendicular to the first direction DR1. To accomplish this, according to certain embodiments, the main plate 100 may be made of a material with high mechanical stiffness that does not deform under high heat and pressure. For example, the main plate 100 may be constructed of a metallic material. Of course, the main plate 100 may be made of a material other than metal, such as aluminum, stainless steel, reinforced plastic, reinforced ceramic, or reinforced glass, as long as the material has good mechanical rigidity. When the main plate 100 is pressed in the second direction DR2, the sub-plates 110 may be pushed sequentially in the second direction DR2.

According to certain embodiments, the main plate 100 and the sub-plates 110 may have slip sheets secured between them. The slip sheets may be pinned to the top of the main plate 100 and the sub-plates 110 and may serve to hold the battery cells before the battery cells are pressurized. The slip sheets may have a length that is less than the size of the battery cells. Preferably, the slip sheets are disposed at a length that covers the bodies of the battery cells. If the tabs of the battery cells are covered by the slip sheets, the pressurizing blocks 150 cannot be electrically connected to the tabs of the battery cells. Each of the slip sheets may comprise a flame retardant coated paper or film.

As shown in FIG. 3, according to certain embodiments, a plurality of battery cells 30 along with the main plate 100 and sub-plates 110 may be disposed in the inner frame 10, with the main plate 100 and sub-plates 110 positioned adjacent to each of the plurality of battery cells 30. Each of the battery cells 30 may be pressurized by the adjacent main plate 100 and the sub-plates 110.

According to certain embodiments, the pressurizing shafts 120 and the pressurizing adjustment member 130 can pressurize the main plate 100. According to certain aspects, the pressurizing adjustment member 130 can rotate each of the pressurizing shafts 120 by rotating a gear. For example, each of the pressurizing shafts 120 can pressurize the main plate 100 by rotating a screw. The pressure exerted on the main plate 100 can be transmitted to the sub-plates 100, whereby the plurality of battery cells 30 can be pressurized together. Each of the pressurizing shafts 120 may have threads, and the sub-plates 110 may be in contact with the threads by bearings or the like. This allows the sub-plates 110 to be moved in the second direction DR2 by rotation of the screw on each of the pressurizing shafts 120. Although not shown, a mounting shaft for mounting the main plate 100 and the sub-plates 110 may be added.

According to certain embodiments, the load cell 140 may measure the pressure applied to the battery cells 30. The load cell 140 may be disposed within the inner frame 10 in a direction in which the pressurizing shafts 120 apply pressure. As shown in FIG. 3, when pressure is applied by the pressurizing shafts 120, the load cell 140 may be in contact with one of the sub-plates 110, and the sub-plate 110 may apply pressure to the load cell 140. According to certain aspects, the load cell 140 can generate a signal to stop pressurizing if pressure is applied above a preset pressure. For example, the load cell 140 can generate a signal to stop pressurization if a pressure greater than 3000 kgf is applied. In doing so, the pressurizing tray 1 can prevent the battery cell 30 from being damaged by excessive pressure being applied to the battery cell 30. According to certain embodiments, the load cell 140 is electrically connected and operable only during the pressurization stage, and not during the charging/discharging process.

According to certain embodiments, the pressurizing blocks 150 may be disposed on the main plate 100 and the sub-plates 110. The pressurizing blocks 150 may move on the main plate 100 and the sub-plates 110 in a direction in which the main plate 100 and the sub-plates 110 extend, i.e., the pressurizing blocks 150 may move in the first direction DR1. Accordingly, even if the length of each of the battery cells 30 in the first direction DR1 changes, the inner frame 10 can be moved to grip the battery cells 30 with different lengths by moving only the pressurizing blocks 150 without having to change the inner frame 10. According to certain aspects, each of the pressurizing blocks 150 may be electrically connected to the wiring 170.

According to certain embodiments, there may be two or more pressurizing blocks 150 on the main plate 100 and the sub-plates 110. The pressurizing blocks 150 may also be in contact with tabs on the battery cells 30. The battery cells 30 illustrated in FIGS. 2 and 3 may be defined as bilateral tabbed battery cells each with tabs located at both ends. The pressurizing blocks 150 may each be in contact with a tab located at one of the ends of the battery cell 30. According to certain aspects, the pressurizing blocks 150 may include a circuit board disposed in contact with the corresponding battery cell 30. The circuit board may be a printed circuit board. According to certain aspects, the pressurizing blocks 150 may be electrically connected to the battery cells 30 through the circuit board.

According to certain embodiments, the inner tabs 160 may be disposed on an inner side of the outer frame 20. The inner tabs 160 may be connected to the pressurizing blocks 150 by wiring 170. Accordingly, signals communicated to the inner tabs 160 from the outside may be communicated to the pressurizing blocks 150 via the wiring 170 that connects to the pressurizing blocks 150, for example by way of the main plate 100 and sub-plates 110. According to certain embodiments, the wiring 170 may be provided in a form of a spring to facilitate length variation. Accordingly, in certain aspects, the wiring 170 will not become disconnected when the main plate 100 and sub-plates 110 are moved in the second direction DR2. In contrast, ff the wiring 170 has a fixed length, the wiring 170 may become disconnected from the pressurizing blocks 150 as the main plate 100 and the sub-plates 110 move. Thereafter, signals communicated to the main plate 100 may be communicated to the battery cell 30 via the pressurizing block 150. In other words, the inner tab 160, the wiring 170, the pressurizing block 150, and the battery cell 30 may be electrically connected.

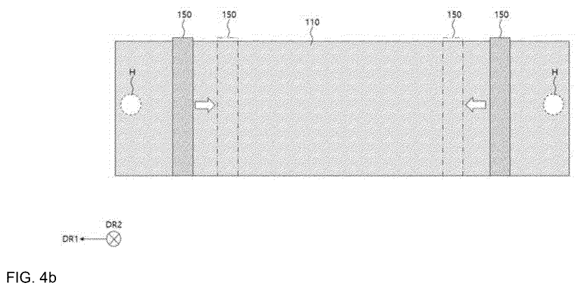

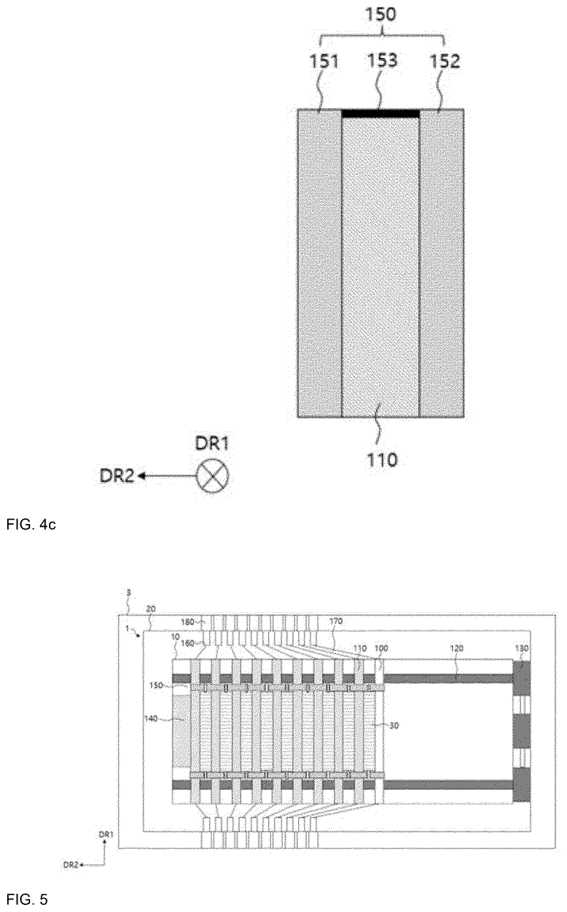

FIGS. 4a to 4c are drawings illustrating one embodiment of a pressurizing block included in the pressurizing tray of FIG. 1.

FIG. 4a is a view of a sub-plate 110 from a second direction DR2, and FIG. 4b is a view of the sub-plate 110 from a direction opposite to the second direction DR2. Referring to FIG. 4a, holes H may be formed at both ends of the sub-plate 110. Pressurizing shafts 120 as described above may be disposed through the holes H. Pressurizing blocks 150 may be disposed on the sub-plate 110. Each of the pressurizing blocks 150 may move on the sub-plates 110 in the first direction DR1 and in a direction opposite to the first direction DR1. This allows each of the pressurizing blocks 150 to move to contact the tab of the battery cell even when the length of the battery cell in the first direction DR1 changes.

FIG. 4c is a side view of the sub-plate 110. The pressurizing block 150 may include a first sub-pressurizing block 151, a second sub-pressurizing block 152, and a connecting member 153. The first sub-pressurizing block 151 and the second sub-pressurizing block 152 may be connected by the connecting member 153. As such, the pressurizing blocks 150 may be disposed on the sub-plates 110 with the plurality of members connected, and may move in the first direction DR1 and in a direction opposite to the first direction DR1.

According to certain embodiments, the first sub-pressurizing block 151 may include a coil spring. Accordingly, the first sub-pressurizing block 151 may be compressed when the tabs of the battery cells are pressed. A circuit board may be disposed in the second sub-pressurizing block 152. According to certain aspects, the second sub-pressurizing block 152 may be connected with the wiring 170 described in FIGS. 2 and 3. Accordingly, the pressurizing block 150 may be electrically connected to the tabs of the battery cell via the second sub-pressurizing block 152. However, while this is exemplary, it is also possible that a circuit board is disposed in the first sub-pressurizing block 151 and that the second sub-pressurizing block 152 comprises a spring.

While FIGS. 4a to 4c have been described with reference to the sub-plates 110, the same can be applied to the main plate 100.

FIG. 5 is a drawing illustrating a cell battery pressurization and charging/discharging system according to an embodiment of the present disclosure.

Referring to FIGS. 1 and 5, the pressurizing tray 1, which is introduced into the charging/discharging device 3 by the transfer device 2, may be electrically connected to the charging/discharging device 3.

The charging/discharging device 3 may include outer tabs 180 disposed internally, and the outer tabs 180 may have a form of grippers. Accordingly, in certain embodiments, the outer tabs 180 may be defined as tab grippers. The outer tabs 180 may contact the inner tabs 160 by gripping the inner tabs 160, and may be electrically connected to the inner tabs 160. Alternatively, the outer tabs 180 and the inner tabs 160 may include a conductive material internally and may be electrically connected by contacting each other. Alternatively, the outer tabs 180 and the inner tabs 160 may each include a circuit board at an end thereof, and may be electrically connected to each other by contacting the respective ends. As such, the charging/discharging device 3 may provide current through the outer tabs 180 to the inner tabs 160. The current may be delivered to the battery cells 30 and serve to charge and discharge the battery cells 30.

The wiring 170, which according to certain aspects, is provided in the form of springs, may be elongated in certain embodiments. Accordingly, the inner tabs 160 may be connected to the pressurizing blocks 150 by the wiring 170 at fixed positions within the outer frame 20. When the main plate 100 and sub-plates 110 are moved in the second direction DR2, the positions of the inner tabs 160 may not change and only the length of the wiring 170 may increase or decrease. The outer tabs 180 may be fixedly disposed in positions corresponding to the inner tabs 160 within the outer frame 20. That is, according to certain embodiments, the positions of the inner tabs 160 and the outer tab 180 are each fixed.

Furthermore, a change in the length of the battery cells 30 in the first direction DR1 does not require replacement of the inner frame 10 because the pressurizing blocks 150 can be moved in the first direction DR1 on the main plate 100 and the sub-plates 110 to grip the tabs of the battery cells 30. Thus, the battery cell pressurization and charging/discharging system 1000 according to one embodiment can use the same inner frame 10, outer frame 20, and charging/discharging device 3 regardless of the size of the battery cells 30. Accordingly, the battery cell pressurization and charging/discharging system 1000 according to one embodiment can save time and money compared to conventional pressurization and charging/discharging systems that require replacing the frame whenever the size of the battery cell 30 changes.

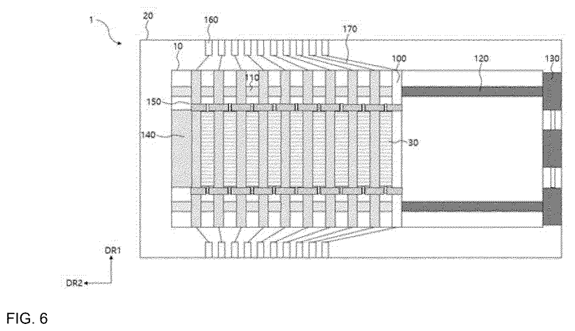

FIG. 6 is a drawing illustrating a pressurizing tray according to one embodiment of the present disclosure. FIG. 6 may be substantially identical to FIG. 1, except that the lengths of the first direction DR1 of the battery cells 30 are reduced. Accordingly, a description of the duplicate configuration will be omitted.

Referring to FIGS. 1 and 6, the pressurizing blocks 150 may move on the main plate 100 and the sub-plates 110 to conform to the lengths of the battery cells 30 when the lengths of the battery cells 30 change. After traveling, the pressurizing blocks 150 can grip the tabs of the battery cells 30. The pressurizing blocks 150 may be electrically connected to the battery cells 30 by gripping the tabs of the battery cells 30. A circuit board may be disposed at the portion where each of the pressurizing blocks 150 grips the tabs of the battery cells 30. The circuit board may be a printed circuit board.

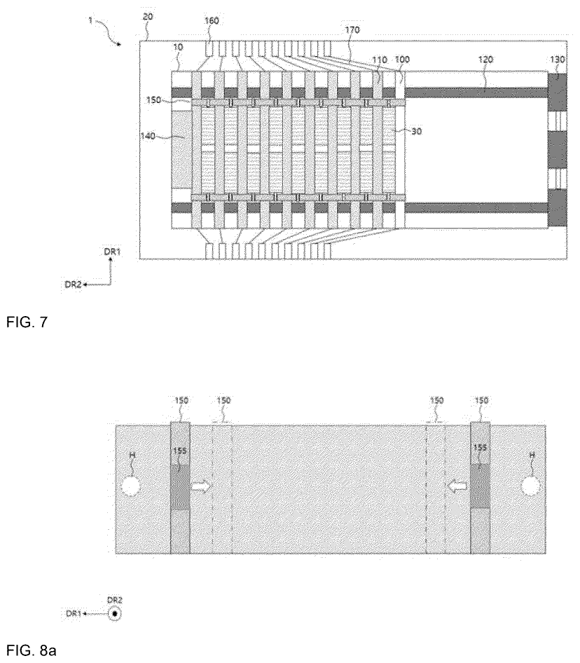

FIG. 7 is a drawing illustrating a pressurizing tray according to another embodiment of the present disclosure. FIG. 7 may be substantially identical to FIG. 1, except that the battery cells 30 have been changed to unidirectionally tabbed battery cells. Accordingly, a description of the duplicate configuration will be omitted.

Referring to FIGS. 1 and 7, the battery cells 30 may be unidirectionally tabbed battery cells rather than bidirectionally tabbed battery cells. A unidirectionally tabbed battery cell may be defined as a battery cell in which the tabs are located on only one side of the battery cells. In this case, battery cells 30 may have tabs located on one end only. The pressurizing blocks 150, which are movable on the main plate 100, may each be in contact with different battery cells 30.

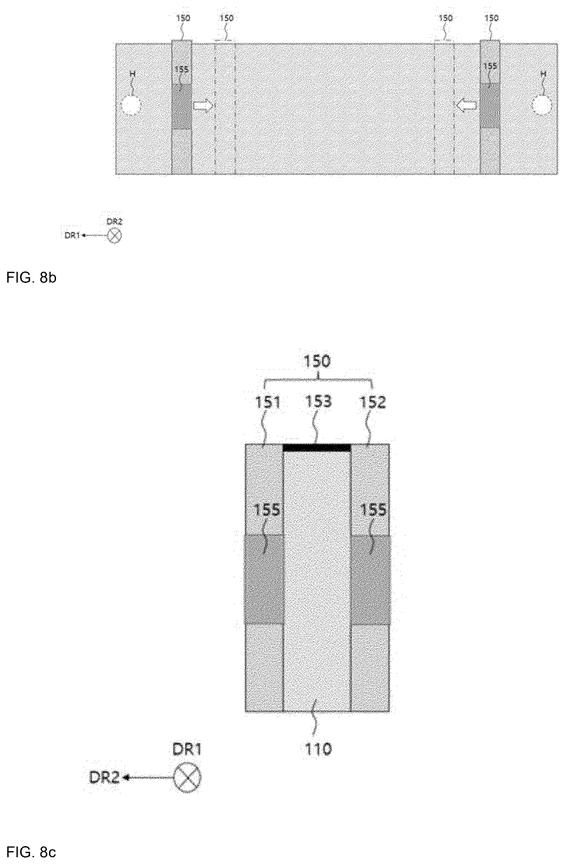

For example, a pressurizing block 150 positioned at an end of the first direction DR1 of one sub-plate 110 may contact a battery cell 30 positioned in the first direction DR1 of the battery cells 30 positioned adjacent to the sub-plate 110, and a pressurizing block 150 positioned in a direction opposite to the first direction DR1 may contact the battery cell 30 positioned in a direction opposite to the first direction DR1, among the battery cells 30 positioned adjacent to the sub-plate 110. In this case, the structure of the pressurizing blocks 150 may be somewhat different from that described above, since the unidirectional tabbed battery cell may have two tabs on one side only. This will be described with reference to FIGS. 8a to 8c.

FIGS. 8a to 8c are drawings illustrating one embodiment of a pressurizing block included in the pressurizing tray of FIG. 7. FIGS. 8a to 8c may be substantially the same as FIGS. 4a to 4c, except for the addition of the insulating member 155. Accordingly, a description of overlapping configurations will be omitted.

Referring to FIGS. 8a to 8c, the insulating member 155 may be disposed within the first sub-pressurizing block 151 and the second sub-pressurizing block 152. The insulating member 155 may also be disposed in only one of the first sub-pressurizing block 151 and the second sub-pressurizing block 152. For example, if a circuit board is disposed in the first sub-pressurizing block 151, the insulating member 155 may be disposed only on the first sub-pressurizing block 151 side. Conversely, if the circuit board is disposed in the second sub-pressurizing block 152, the insulating member 155 can be disposed only on the second sub-pressurizing block 152 side.

The insulating member 155 may serve to insulate the circuit boards disposed at the top and bottom of the sub-pressurizing block where the circuit boards are disposed. Thus, an upper portion of the sub-pressurizing block in which the circuit board is disposed may contact a tab of one of the two tabs of the battery cell, and a lower portion of the sub-pressurizing block may contact a tab of the other of the two tabs of the battery cell.

In this case, a plurality of wirings 170 shown in FIG. 7 may be provided and connected to top and bottom of the sub-pressurizing block, respectively.

Although the present disclosure has been described in detail above with respect to preferred embodiments of the present disclosure, the scope of the present disclosure is not limited thereto, and various modifications and improvements of those skilled in the art utilizing the basic concepts of the present disclosure as defined in the following claims are also within the scope of the present disclosure.

### EXPLANATION OF SYMBOLS

1: Pressurizing tray
2: Transfer device
3: Charging/discharging device
10: Inner Frame
20: Outer Frame
30: Battery cell
100: Main plate
110: Sub plate
120: pressurizing shaft
130: pressurizing adjustment member
140: Load Cell
150: pressurizing block
160: Inner tabs
170: Wiring
180: Outer Tabs
151: First sub-pressurizing block
152: Second sub-pressurizing block
153: Connecting member
155: Insulating member

What is claimed is:

1. A system for pressurizing and charging/discharging a battery cell, comprising:
an inner frame into which a battery cell is loaded;
a plate for pressurizing the battery cell;
a pressurizing block movable on the plate in a direction in which the plate extends, and gripping the battery cell; and
an outer frame disposed outside the inner frame, and having an inner tab electrically connected with the pressurizing block by wiring.

2. The battery cell pressurization and charging/discharging system of claim 1, wherein the pressurizing block comprises a circuit board disposed in contact with the battery cell.

3. The battery cell pressurization and charging/discharging system of claim 1, further comprising a load cell disposed within the inner frame and capable of measuring a pressure exerted on the battery cell.

4. The battery cell pressurization and charging/discharging system of claim 1, further comprising a pressurizing shaft for pressurizing the plate, wherein the pressurizing shaft pressurizes the plate by rotation.

5. The battery cell pressurization and charging/discharging system of claim 4, wherein the rotation is a screw rotation.

6. The battery cell pressurization and charging/discharging system of claim 1, wherein the pressurizing block grips a tab of the battery cell.

7. The battery cell pressurization and charging/discharging system of claim 6, wherein the battery cell is a bilateral tabbed battery cell with tabs provided at both ends.

8. The battery cell pressurization and charging/discharging system of claim 6, wherein the battery cell is a unidirectionally tabbed battery cell having tabs provided at one end only.

9. The battery cell pressurization and charging/discharging system of claim 6, wherein two or more pressurizing blocks are disposed on the plate.

10. The battery cell pressurization and charging/discharging system of claim 1, further comprising:
a transfer device to transfer the outer frame; and
a charging/discharging device into which the transferred outer frame is placed,
wherein the charging/discharging device has an outer tab electrically connected with the inner tab, and
wherein a current applied by the charging/discharging device is transferred to the battery cell via the outer tab, the inner tab, and the pressurizing block.

11. The battery cell pressurization and charging/discharging system of claim 1, wherein the outer tab is a tab gripper that grips and electrically connects the inner tab.

12. The battery cell pressurization and charging/discharging system of claim 1, wherein wiring connects the inner tab to the pressurizing block, the wiring being in a form of a spring.
